(19) United States
(12) Patent Application Publication
(10) Pub. No.: US 2012/0030234 A1
(43) Pub. Date: Feb. 2, 2012

(54) METHOD AND SYSTEM FOR GENERATING A SEARCH QUERY

(76) Inventors: Sitaram RAMACHANDRULA, Bangalore (IN); Anand Balasubramanian, Bangalore (IN); Dinesh Mandalapu, Bangalore (IN); Suryaprakash Kompalli, Bangalore (IN); Anjaneyulu Seetha Rama Kuchibhotla, Bangalore (IN)

(21) Appl. No.: 12/946,880

(22) Filed: Nov. 16, 2010

(30) Foreign Application Priority Data
Jul. 31, 2010 (IN) 2184/CHE/2010

(51) Int. Cl. G06F 17/30

(52) U.S. Cl. 707/769; 707/E17.014

(57) ABSTRACT

A computer-implemented method for generating a search query for searching a source of data is disclosed. The method comprises:
a) receiving image and/or text data;
b) extracting one or more search query parameters from the image and/or text data; and
c) generating the search query from the or each extracted parameter.

### RELATED APPLICATION

Benefit is claimed under 35 U.S.C. 119(a)-(d) to Foreign application Serial No. 2184/CHE/2010 entitled “Method and System for Generating a Search Query” by Hewlett-Packard Development Company, L.P., filed on Jul. 31, 2010, which is herein incorporated in its entirety by reference for all purposes.

### BACKGROUND

Searching of computerised data sources such as the Internet or a database is usually initiated by a user entering a search query into a search engine, in the case of the Internet, or a database front-end, in the case of a database. The search query will depend on the data that is being requested by the search, but is typically a few keywords.

In reality, such methods of searching are limited in application to computer devices with suitable text entry interface devices, such as a keyboard. Even then, some devices, such as mobile phones, have very small keyboards that are cumbersome to use, making the entry of a search query awkward. Furthermore, even when a full-size keyboard is available, such as on a laptop or desktop personal computer, the user typically needs to interrupt the task they are currently engaged in to launch a browser or other application to input the search query.

Recently, it has become possible to initiate a search based on an image (for example, using Google Goggles). An entire image is used as the search query.

### BRIEF DESCRIPTION OF THE DRAWINGS

For a better understanding, embodiments will now be described, purely by way of example, with reference to the accompanying drawings, in which:

FIG. 1 shows a flow chart of a method for generating a search query for searching a source of data; and

FIG. 2 shows a detailed flow chart of a step of extracting search query parameters from FIG. 1.

### DETAILED DESCRIPTION

A first embodiment provides a computer-implemented method for generating a search query for searching a source of data, the method comprising:

a) using a computer device, receiving image and/or text data;

b) using said computer device, extracting one or more search query parameters from the image and/or text data; and

c) using said computer device, generating the search query from the or each extracted parameter.

Hence, the embodiment provides a way in which any computer device capable of receiving image and/or text data (for example, via a digital camera or e-mail) can extract the necessary information from the received data to generate a search query. Thus, a mobile phone with camera, for example, could take a digital photograph of a subject containing a desired search term and extract the search query from the digital photograph. The problems set out above are therefore overcome.

The image and/or text data could be, for example, a digital photograph or text received by the computer device via e-mail or by opening a suitable file, such as a Portable Document Format (PDF) or Microsoft Word file. It could also be a digital representation of a sheet document.

An embodiment provides a system for generating a search query for searching a source of data, the system comprising a processor adapted to perform the steps of a method for generating a search query for searching a source of data, the method comprising:

a) using the processor, receiving image and/or text data;

b) using said processor, extracting one or more search query parameters from the image and/or text data; and

c) using said processor, generating the search query from the or each extracted parameter.

Another embodiment provides a computer program comprising a set of computer-readable instructions adapted, when executed on a computer device, to cause said computer device to carry out a method for generating a search query for searching a source of data, the method comprising:

a) using said computer device, receiving image and/or text data;

b) using said computer device, extracting one or more search query parameters from the image and/or text data; and

c) using said computer device, generating the search query from the or each extracted parameter.

Yet another embodiment provides a computer-readable medium having computer-executable instructions stored thereon that, if executed by a computer device, cause the computer device to perform a method for generating a search query for searching a source of data, the method comprising:

a) using said computer device, receiving image and/or text data;

b) using said computer device, extracting one or more search query parameters from the image and/or text data; and c) using said computer device, generating the search query from the or each extracted parameter.

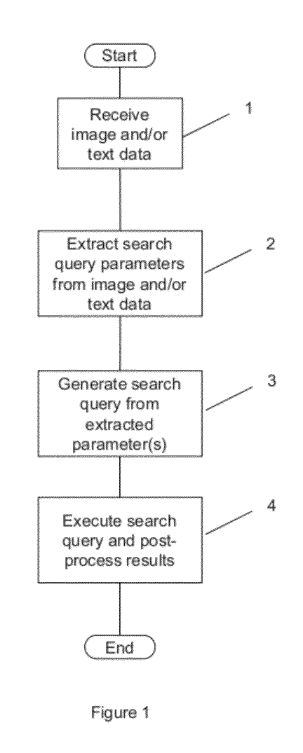

A flowchart of a method incorporating the method of the first embodiment is shown in FIG. 1. The method starts with step 1, in which image and/or text data is received by a computer device. Whether the data is image and/or text data will depend on the source of information from which the search query is to be generated.

For example, it may be that the source of information is a digital photograph of an article bearing text or an image that a user would like to search for, it may be a digital photograph of an article (for example a building or a car) that the user would like to use as the basis for an image search, it may be a sheet document that is scanned or photographed digitally, or it may be simply a text-based file (such as a Microsoft Word or PDF file) that is stored in a file store accessible to the computer device.

Thus, step (a) of the method of the first embodiment may comprise one of: scanning a sheet document, taking a digital photograph of an article, and retrieving the image and/or text data from a file store.

In step 2, one or more search query parameters are extracted from the image and/or text data. For example, a user could annotate a sheet document with handwritten annotations which indicate the search query parameters. The annotations are detectable by scanning the sheet document, as mentioned above.

There are various other ways in which the annotations may be made, depending on the specific application. For example, if the data is text data, such as from a Microsoft Word file, then the search query parameters could include an item to be searched for that is based on words in the data that have been highlighted using the highlighter tool in Microsoft Word. Other possibilities include use of a tablet computer on which a stylus can be used to indicate search query parameters on a document. The search query parameters may be indicated by encircling or underlining keywords or by writing details of the parameter using the stylus. The stylus may also be used to indicate an image or a region of an image which should form a search query parameter. A graphical button or similar device may be provided in the user interface for the user to press when they have completed entering search query parameters using the stylus.

Thus, step (b) of the method of the first embodiment may comprise detecting, in a digital representation of a sheet document, one or more indicia made on the sheet document, the or each indicia indicating a respective search query parameter; and extracting the respective search query parameters from the digital representation. In this regard, it is important to note that the digital representation of a sheet document may include both scanned paper documents and documents generated wholly on a computer device, such as Microsoft Word of PDF documents.

The or each indicia may include an indicia, which expresses a search query parameter. Furthermore, the or each indicia may include an indicia indicating an associated region of content on the sheet document, which includes a search query parameter.

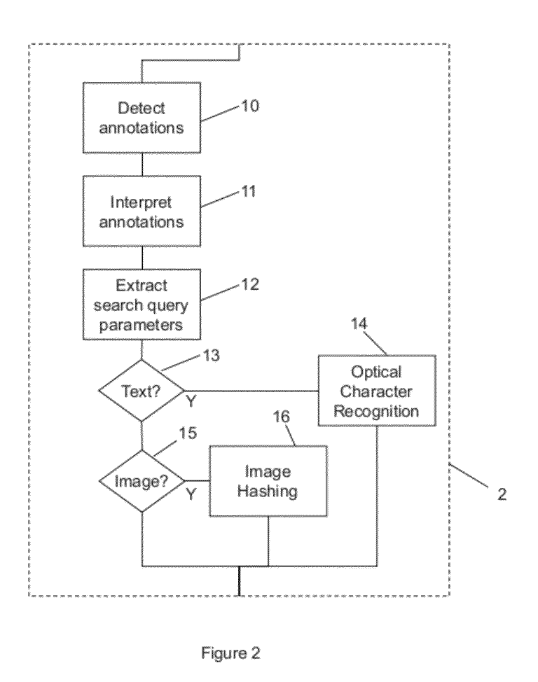

FIG. 2 shows details of a specific implementation of step 2 in FIG. 1, in which the search query parameters are extracted from a sheet document that has been annotated by a user to indicate regions of document content representing the search query parameters. The user, after making the annotations, scans the document and the image data representing the document is received by the computer device in step 1. Thus, in this specific implementation, the or each indicia is a manuscript annotation made on the sheet document.

In step 10, the manuscript annotations made by the user on the sheet document are detected from the scanned digital representation by a handwriting recognition module. In step 11, the detected annotations are interpreted by the handwriting recognition module to determine the user's intentions for the search. Each of the annotations may indicate or express a search query parameter.

Each of the search query parameters identified is then extracted in step 12. If the annotation expresses the search query parameter then this is inherently done during the handwriting recognition step 11, and the search query parameter is available from the handwriting recognition module. If, on the other hand, the annotation simply indicates a search query parameter on the sheet document then further processing is required to extract the parameter.

For example, if the annotation points to a region of text then this is detected in step 13 and optical character recognition is performed in step 14 to extract the text to obtain the search query parameter. If, on the other hand, the annotation points to an image then this is detected in step 15 and the image to be searched extracted by feature point based image hashing in step 16. Other possibilities include extraction of codes from a bar-code pointed to by an annotation.

At the end of the processing of FIG. 2, a set of search query parameters is available, which is used to construct a search query in step 3. This search query is then executed in step 4 (either on a default search interface or on one specified by a search query parameter). Any post-processing, examples of which are set out below, instructed by the search query parameters is then performed.

The search query parameters may include a variety of items. For example, they may include an item to be searched. The item to be searched may include a text element, in which case it can be extracted from the digital representation of the sheet document using optical character recognition, and/or it may include a graphical element, in which case it can be extracted by feature point based image hashing.

The search query parameters may also include a parameter possibly extracted by feature point based image hashing, which indicates a data source for searching when the search query is executed. For example, it may specify an Internet search engine to use or the address of a database server to query.

The search query parameters may also include a post-processing instruction, which indicates whether a set of search results received in response to execution of the search query should be e-mailed to a recipient, printed, or saved to a file. In addition, or instead, the results could simply be displayed on a display attached to the computer device.

The annotations made will depend on the specific implementation of the handwriting recognition module and the search query parameter to which they relate. For example, an item to be searched could be underlined or encircled, indicated with an arrow or an asterisk. A search interface to be used could be specified by a user writing “[engine=X]” where X is an Internet search engine to be used. Post-processing could be specified by a user writing “[email=user@example.com]” to e-mail the results to a specific e-mail address or “[print]” to print the results out. Some examples of the annotations that could be made and how they might be interpreted are set out below:

1) As mentioned above, search keywords could be identified by underlining the words to be searched in a sheet document. These keywords would then be combined from left to right and top to bottom in order to specify the item to be searched. If multiple keywords are underlined then the ordering of the keywords can be provided by associated numbers, which may be annotated in the margin. If there are multiple keywords in a line then multiple associated numbers could be specified in the margin. In addition to specifying the keywords, the user may include annotations to indicate whether they should be combined to form a search query using one or more Boolean operators, such as “AND”, “OR” or “NOT”.
2) It is also possible to indicate that a search should be performed for documents corresponding to references in a paper. For example, a tick mark could be placed next to each reference of interest. The user could also specify that they should be downloaded by writing “[download]” or a similar instruction in a blank area of the paper.
3) An image on a sheet document can be identified by making suitable annotations, such as brackets around the image. The image can then form part of the search either alone or along with indicated keywords. In addition, annotations can be made to indicate whether an ‘exact’ match to the image is required, for example by writing an “E” in a circle in a blank area of the document, or whether images that are similar to the image should be found, for example by writing an “S” in a circle in the blank area of the document. Rather than use an entire image, regions of an image may be selected to form a search query parameter. This avoids the problem with Google Goggles, for example, which lacks flexibility as the search is by default made for the entire image. This can result in too many search results being retrieved, many of which may be of no interest. This represents a burden to the user in filtering the results.
4) There are situations where it is desirable to find the original source for a paragraph of text or to provide a whole paragraph as a search query to identify similar documents rather than just provide a few keywords. Handwritten annotations such as brackets could be placed around the paragraph of interest to identify it. In addition, a “Q” in a circle could be marked in a blank area of the document to indicate that the paragraph is to be used as a query, or an “S” in a circle could be used to indicate that similar documents should be found.
5) In addition to the search query itself, the annotations could relate to a search query parameter that instructs a post-processing step. Options for post-processing include printing the results, for example by writing a “P” in a circle in a blank area of the document; e-mailing the results to a recipient, for example by writing an “E” in a circle with the e-mail address of the recipient in square brackets; or saving the results by writing an “S” in a circle with a file name in square brackets. One of these could be a default or could be pre-configured by a user in the event that no post-processing step is specified.
6) A search query parameter could be specified to indicate what search engine or type of database should be searched. In other words, the parameter can be used to select a data source for the search. This could be specified by writing, for example, “[engine=X]”, where X is the search engine of interest. The data source specified by this directive could be a front-end to a database application that can interpret the query and provide the required results or a specific website identified by a Uniform Resource Locator (URL) or by a keyword that indicates the URL. Alternatively, the document itself may be analysed, for example by feature point based image hashing or locally likely arrangement hashing (LLAH), to identify the data source that should be used (for example, if the Wikipedia logo is detected then that could be used to determine that the search should be performed on Wikipedia). Again, a default search engine could be predefined or pre-configured by a user in case no particular data source is specified or detected.
7) A search query parameter could be specified to indicate the number of search results that should be provided. By default, the configuration for the number of search results that is returned may be limited to the number that fits on one printed page. However, there may be situations where more or fewer results are required. Thus, the value may be overridden, for example by writing “[results=Y]”, where Y is the number of results that should be returned.
8) The technique may also be used to query a database. For example, the status of a payment request may be obtained from a database, which might be identified by a barcode printed on the document. By writing “STATUS” in a circle on the document and by putting brackets around the payment request number for which the status needs to be obtained, a scanner can generate the query and then return the results when the document is scanned. Thus, in more general terms, a user can point to an identifier on the paper and ask for different related information to be retrieved. For example, the annotation could point to an account number or invoice number and the annotation could instruct the latest entries of the account or status of payment of an invoice to be retrieved and printed or e-mailed to a recipient.
9) A user can expand the selection of keywords across multiple pages of a document (and indeed, the front and back sides of a single page). The pages can then be scanned together to commence the search. For example, a user could indicate that further search query parameters are specified on a subsequent page by writing the command “CONTD” in a circle on a blank area of a page of a sheet document. The actual search would be commenced once a page that does not have this command is encountered.
10) In addition to indicating keywords or items to be searched by underlining or delimiting with brackets, a user can specify additional keywords by writing them on a sheet document. The handwritten keywords will be analysed by a handwriting recognition module and the resultant text output used to augment the query. The keywords can be written in free space on the sheet document where the user can write clearly.

Default values could be provided for many of the parameters in the above paragraphs 1 to 10. These defaults may either be specified by the system or provided by a personal profile set up by a user and stored on the computer device or on a remote device (e.g. on the Internet). The profile may store information such as the geographical location of a user, the user's areas of interest, a default search engine to use and so on. Thus, the method may further comprise extracting one or more search query parameters from a file.

After the search query has been generated and/or after the search results have been retrieved, it is possible to allow user interaction to make corrections or changes to the search query (for example, to correct any errors due to incorrect handwriting recognition or making other changes to the search query parameters that have been extracted) and/or to allow the application of one or more filters to the search results (for example, to modify the number of results shown).

The method and system presented offers many advantages. For example, a search can be performed without a PC, provided a network-connectable device such as a scanner (including multi-function printer/scanner devices) or a mobile phone with a camera is available; a search can be performed where keyboard entry is not very convenient, such as with small mobile devices that have in-built cameras; an image-based search can be performed where the image to be searched is printed on a sheet document; batch searches can be performed from multiple sheets, each of which is annotated and fed through the automatic document feeder of a scanner; and f) since the search does not require ongoing user interaction, the search may be performed as a background job for both single and batch searches.

We claim:

1. A computer-implemented method for generating a search query for searching a source of data, the method comprising:
a) using a computer device, receiving image and/or text data;
b) using said computer device, extracting one or more search query parameters from the image and/or text data; and
c) using said computer device, generating the search query from the or each extracted parameter.

2. A method according to claim 1, wherein step (a) comprises one of: scanning a sheet document, taking a digital photograph of an article, and retrieving the image and/or text data from a file store.

3. A method according to claim 1, wherein step (b) comprises detecting, in a digital representation of a sheet document, one or more indicia made on the sheet document, the or each indicia indicating a respective search query parameter; and extracting the respective search query parameters from the digital representation.

4. A method according to claim 3, wherein the or each indicia includes an indicia expressing a search query parameter.

5. A method according to claim 3, wherein the or each indicia includes an indicia indicating an associated region of content on the sheet document, which includes a search query parameter.

6. A method according to claim 3, wherein the or each indicia is a manuscript annotation made on the sheet document.

7. A method according to claim 6, wherein the or each manuscript annotation is detected by a handwriting recognition module.

8. A method according to claim 1, wherein the search query parameters include an item to be searched.

9. A method according to claim 8, wherein the item to be searched includes a text element, which is extracted by optical character recognition.

10. A method according to claim 8, wherein the item to be searched includes a graphical element, which is extracted by feature point based image hashing.

11. A method according to claim 1, wherein the search query parameters include a post-processing instruction, which indicates whether a set of search results received in response to execution of the search query should be e-mailed to a recipient, printed, or saved to a file.

12. A method according to claim 1, wherein the search query parameters include a parameter possibly extracted by feature point based image hashing, which indicates a data source for searching when the search query is executed.

13. A method according to claim 1, further comprising extracting one or more search query parameters from a file.

14. A system for generating a search query for searching a source of data, the system comprising a processor adapted to perform the steps of a method for generating a search query for searching a source of data, the method comprising:
a) using the processor, receiving image and/or text data;
b) using said processor, extracting one or more search query parameters from the image and/or text data; and
c) using said processor, generating the search query from the or each extracted parameter.

15. A computer program comprising a set of computer-readable instructions adapted, when executed on a computer device, to cause said computer device to carry out a method for generating a search query for searching a source of data, the method comprising:
a) using said computer device, receiving image and/or text data;
b) using said computer device, extracting one or more search query parameters from the image and/or text data; and
c) using said computer device, generating the search query from the or each extracted parameter.
